(19) United States
(12) Patent Application Publication
(10) Pub. No.: US 2012/0139504 A1
(43) Pub. Date: Jun. 7, 2012

(54) APPARATUS FOR OBTAINING INFORMATION ENABLING THE DETERMINATION OF THE MAXIMUM POWER POINT OF A POWER SOURCE

(75) Inventor: Gustavo Buiatti, Rennes Cedex 7 (FR)

(73) Assignee: MITSUBISHI ELECTRIC CORPORATION, Chiyoda-ku (JP)

(21) Appl. No.: 13/382,758

(22) PCT Filed: Jul. 8, 2010
(86) PCT No.: PCT/EP2010/059803

§ 371 Date: Feb. 24, 2012

(30) Foreign Application Priority Data
Jul. 10, 2009 (EP) 09165141.4

(51) Int. Cl. H02J 7/00

(52) U.S. Cl. 320/166

(57) ABSTRACT

An apparatus for determining information enabling determination of a maximum power point of a power source providing at a first time period a direct current, the apparatus including at least a capacitor, a mechanism for charging the capacitor during a second time period and for discharging the capacitor in a third time period, and a mechanism for monitoring voltage and current variations on the capacitor. During the first time period, the direct current does not go through the mechanism for charging the capacitor.

The present invention relates generally to an apparatus for obtaining information enabling the determination of the maximum power point of a power source like a photovoltaic cell or an array of cells or a fuel cell.

A photovoltaic cell directly converts solar energy into electrical energy. The electrical energy produced by the photovoltaic cell can be extracted over time and used in the form of electric power. The direct electric power provided by photovoltaic cell is provided to conversion devices like DC-DC up/down converter circuits and/or DC/AC inverter circuits.

However, the current-voltage droop characteristics of photovoltaic cells cause the output power to change nonlinearly with the current drawn from photovoltaic cells. The power-voltage curve changes according to climatic variations like light radiation levels and operation temperatures.

The near optimal point at which to operate photovoltaic cells or arrays of cells is at or near the region of the current-voltage curve where power is greatest. This point is denominated as the Maximum Power Point (MPP).

It is important to operate the photovoltaic cells around the MPP to optimize their power generation efficiency.

As the power-voltage curve changes according to climatic variations, the MPP also changes according to climatic variations.

It is then necessary to be able to identify the MPP at any time.

By inserting components into the current path between the power source and the load, some power losses occur as components are not perfect.

The present invention aims at providing an apparatus which enables to obtain information representative of the output current and voltage variations of the power source for example, in order to determine the MPP of the power source and wherein the power losses are reduced as much as possible.

To that end, the present invention concerns an apparatus for determining information enabling the determination of the maximum power point of a power source providing at a first time period a direct current, the apparatus comprising at least a capacitor, means for charging the capacitor during a second time period and means for discharging the capacitor in a third time period, means for monitoring the voltage and the current on the capacitor, characterised in that, during the first time period, the direct current does not go through the means for charging the capacitor.

Thus, it is possible to obtain information representative of the output voltage and current variations of the power source without having important power losses.

Furthermore, in most of DC/DC and/or DC/AC converters, the capacitor is already available on their input for filtering purposes. The capacitor can be also used for monitoring the voltage and current variations during at least one particular period of time. The monitored voltage and current variations enable the obtaining of information like the wanted voltage-current/voltage-power droop characteristics of the power source at any time. The present invention avoids to add any other extra capacitor to the system.

According to a particular feature, the direct current is intended to a load during the first time period.

According to a particular feature, the means for discharging the capacitor are composed of a resistor and a first switch, a first terminal of the resistor is connected to a first terminal of the power source and to a first terminal of the first switch, a second terminal of the resistor is connected to a first terminal of the capacitor, the second terminal of the capacitor is connected to a second terminal of the power source and to a second terminal of the first switch.

Thus, with this topology, the capacitor can be discharged without the need of an additional switch in the current path between the power source and the load, avoiding the losses that would appear on the first switch during normal operation of the converter connected to the power source i.e. during the first time period. Consequently, a more efficient topology for obtaining information enabling the determination of the MPP is obtained.

According to a particular feature, the means for charging the capacitor during the second time period comprise a second switch.

Thus, during normal operation, the losses on the second switch are much reduced if compared with a switch on the main path.

According to a particular feature, the second switch is connected in parallel with the resistor.

Thus, during normal operation, i.e. during the first time period, the capacitor which is also used as input filter is always operative because the second switch creates a short-circuit in parallel with the resistor and there is no power losses on the resistor under this condition.

Furthermore, the losses on the second switch are much reduced if compared with a switch on the main path, since the current through the capacitor under normal operation is very small due to the very small voltage ripple on it.

According to a particular feature, the apparatus for obtaining information enabling the determination of the maximum power point of the power source further comprises a third switch for disconnecting the load from the power source during the second and third time periods.

Thus, it is possible to disconnect the power source from the load periodically, wherein the load may be a DC/DC or a DC/AC converter, in order to obtain information enabling the determination of the maximum power point i.e. to perform a voltage-current/voltage-power droop characterization of the power source. Usually the third switch is already comprised on the DC/DC or DC/AC topologies.

Furthermore, it is not necessary to have a variable load which would require a much longer time to operate in different points of the curve, also leading to lower power generation efficiency.

According to a particular feature, the means for monitoring the voltage and the current on the capacitor sample the voltage on the capacitor at consecutive time samples during the second time period.

Thus, it is possible to estimate the current variations from the calculation of the voltage derivative eliminating the need of an expensive current sensor that leads to additional power losses.

The cost and efficiency are improved.

Estimation of the voltage-current/voltage-power droop characteristics of the power source is performed by associating every pair of estimated current and measured voltage during this second time period.

According to a particular feature, the measured voltage at consecutive samples surrounding a given sample are processed using a fitted mathematical function which is obtained by minimizing the sum of the squares of the difference between the measured voltages at consecutive samples and mathematical functions in order to obtain a processed voltage for the given sample.

Thus, the noise that might appear on the measured voltage sample is already filtered by the polynomial function resulting in an improved voltage estimation for that sample.

According to a particular feature, the mathematical functions are polynomial functions of a given order with real coefficients.

According to a particular feature, the current for the given sample is determined by multiplying the capacitance value of the capacitor by the voltage derivative of the given sample, the voltage derivative being obtained through the fitted mathematical function for the given sample.

Thus, through the use of a fitted mathematical function it is possible to realize two useful operations simultaneously: filter the voltage sample and estimate its voltage derivative.

According to a particular feature, the apparatus for obtaining information enabling the determination of the maximum power point of the power source further comprises means for sampling the voltage on the capacitor during the third time period in order to determine the capacitance value of the capacitor.

Thus, it is possible to accurately determine the actual capacitance value every time that information enabling the determination of the maximum power point of the power source are obtained, avoiding errors that may appear on the current estimation due to temperature and aging effects on the capacitor.

According to a particular feature, the determined capacitance value is used for determining the current for the given sample.

Thus, it is not necessary at all to have a current sensor installed into the system.

Furthermore, the results obtained from the voltage derivative calculation for each sample and the correspondent capacitance value lead to very accurate current estimation.

According to a particular feature, the capacitor, the means for monitoring voltage and current and the third switch are components of a merged buck/boost converter.

Thus, it is possible to perform the voltage-current/voltage-power droop characterisation of the power source by adding few components to the buck/boost converter, resulting in a low cost modification that can lead to a much more efficient power usage from the power source.

The characteristics of the invention will emerge more clearly from a reading of the following description of an example embodiment, the said description being produced with reference to the accompanying drawings, among which:

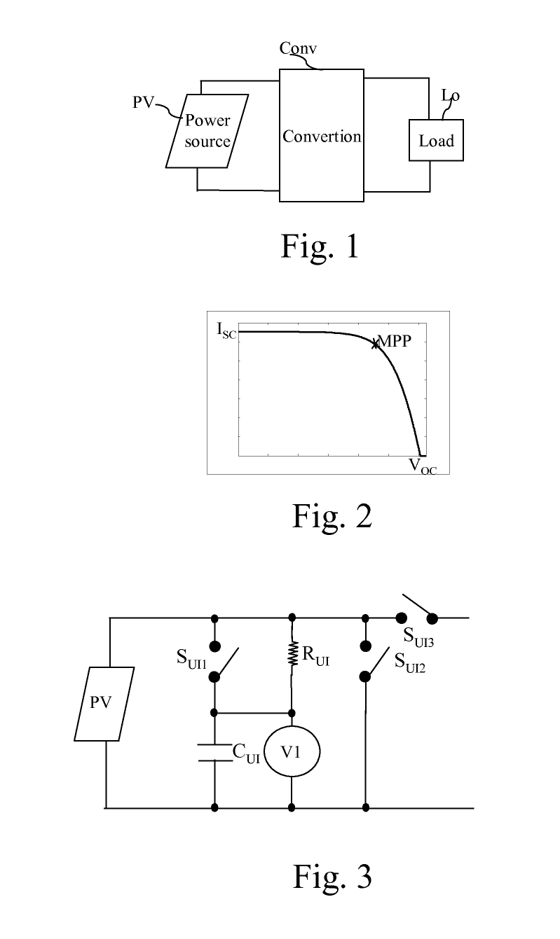

FIG. 1 is an example of an energy conversion system wherein the present invention may be implemented;

FIG. 2 is an example of a curve representing the output current variations of a power source according to the output voltage of the power source;

FIG. 3 is an example of an electric circuit comprising a capacitor according to the present invention which obtains information enabling the determination of the maximum power point of the power source;

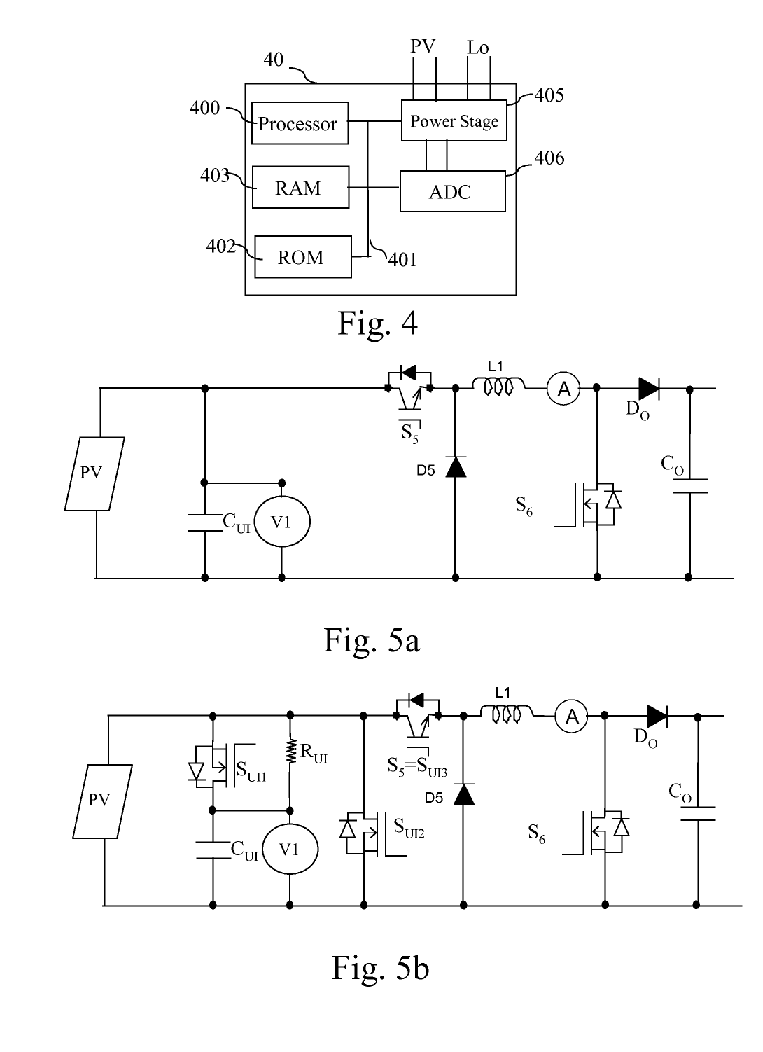

FIG. 4 represents an example of a device comprising an energy conversion device and the electric circuit comprising the capacitor according to the present invention;

FIG. 5a is an example of a merged buck/boost converter able to step-down or to step-up the input voltage without inverting voltage polarity;

FIG. 5b is an example of a particular implementation of the electric circuit comprising the capacitor according to the present invention in the merged buck/boost converter;

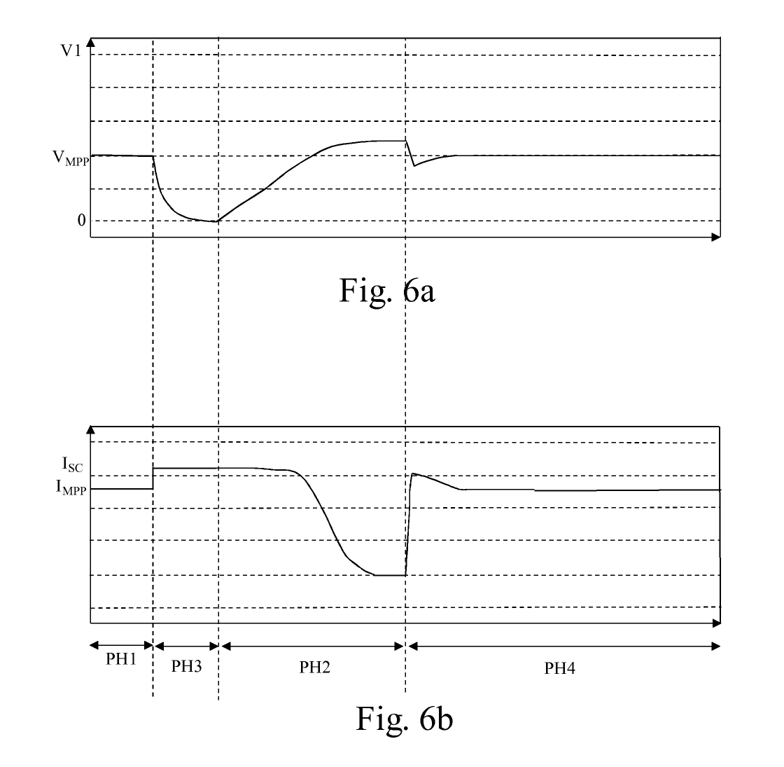

FIG. 6a is an example of the capacitor voltage variations measured according to the present invention;

FIG. 6b is an example of power source current variations obtained according to the present invention;

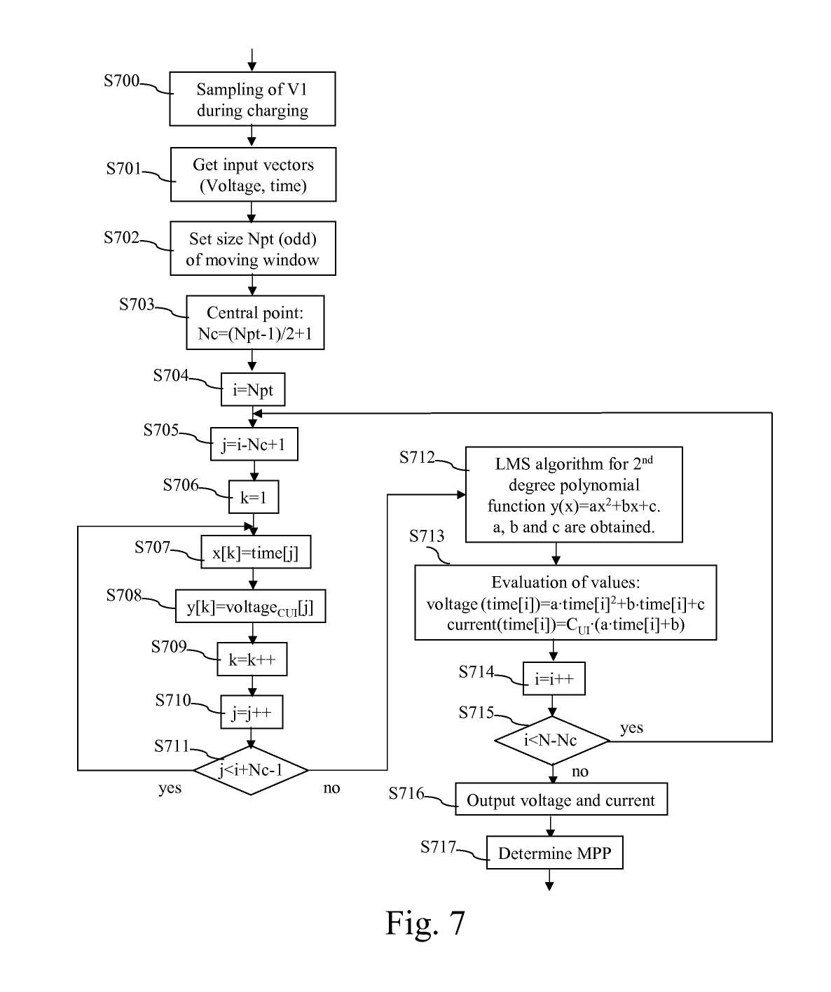

FIG. 7 is an example of an algorithm for determining the maximum power point of the power source according to a particular mode of realisation of the present invention;

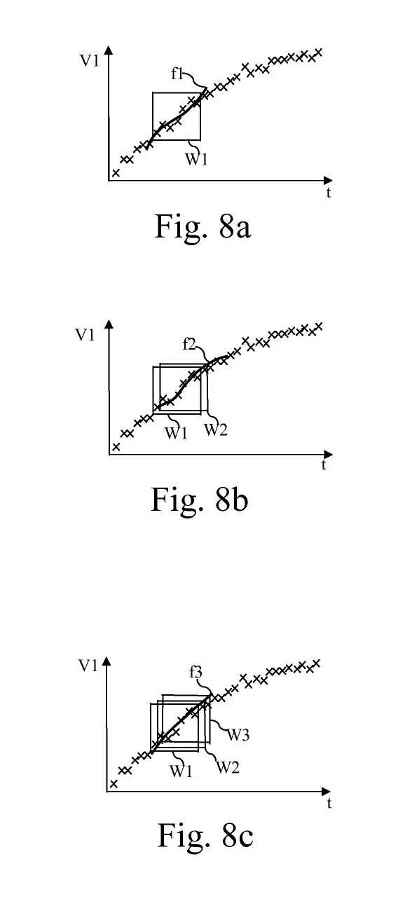

FIG. 8a is an example of a first window which is used to determine a curve based on the fitting of suitable mathematical functions, for example polynomial functions with real coefficients, according to a particular mode of realisation of the present invention;

FIG. 8b is an example of a second window which is used to determine a curve based on the fitting of suitable mathematical functions, for example polynomial functions with real coefficients, according to a particular mode of realisation of the present invention;

FIG. 8c is an example of a third window which is used to determine a curve based on the fitting of suitable mathematical functions, for example polynomial functions with real coefficients, according to a particular mode of realisation of the present invention;

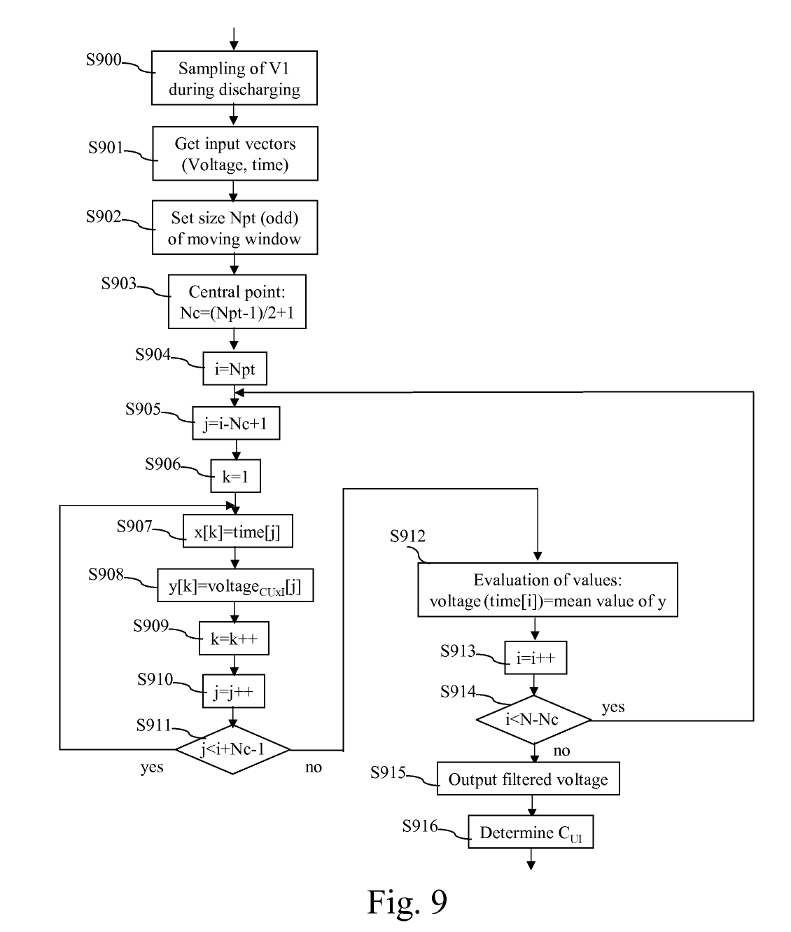

FIG. 9 is an example of an algorithm for determining the capacitance value of the capacitor used for obtaining information enabling the determination of the maximum power point of the power source according to a particular mode of realisation of the present invention.

FIG. 1 is an example of an energy conversion system wherein the present invention may be implemented.

The energy conversion system is composed of a power source PV like a photovoltaic cell or an array of cells or a fuel cell connected to a conversion device Conv like a DC-DC step-down/step-up converter and/or a DC/AC converter also named inverter, which output provides electrical energy to the load Lo.

The power source PV provides current intended to the load Lo. The current is converted by the conversion device Conv prior to be used by the load Lo.

FIG. 2 is an example of a curve representing the output current variations of a power source according to the output voltage of the power source.

On the horizontal axis of FIG. 2, voltage values are shown. The voltage values are comprised between null value and the open circuit voltage V_{OC}.

On the vertical axis of FIG. 2, current values are shown. The current values are comprised between null value and the short circuit current I_{Sc}. At any given light level and photovoltaic array temperature there is an infinite number of current-voltage pairs, or operating points, at which the photovoltaic array can operate. However, there exists a single MPP for a given light level and photovoltaic array temperature.

FIG. 3 is an example of an electric circuit comprising a capacitor according to the present invention which obtains information enabling the determination of the maximum power point of the power source.

The electric circuit may be comprised partially or totally in the conversion device Conv or may be added to the conversion device Conv.

The positive terminal of the power source PV is connected to the first terminal of a switch S_{UI}, to the first terminal of the resistor R_{UI}, to the first terminal of a switch S_{UI2} and to the first terminal of a switch S_{UI3}.

The second terminal of the switch S_{UI1} is connected to the positive terminal of a capacitor C_{UI} and to the second terminal of the resistor R_{UI}.

The negative terminal of the power source PV is connected to the second terminal of the switch S_{UI2} and to the negative terminal of a capacitor C_{UI}.

V1 represents the voltage of C_{UI}. The voltage is for example measured using an analogue to digital converter.

The electric circuit comprises also a switch S_{UI3} which function is to connect or not the load Lo to the power source PV. Thus, the second terminal of the switch S_{UI3} is connected to a converter Conv or is part of the converter which is then connected to the load Lo such as indicated in FIG. 1.

FIG. 4 represents an example of a device comprising an energy conversion device and the electric circuit comprising the capacitor according to the present invention.

The device 40 has, for example, an architecture based on components connected together by a bus 401 and a processor 400 controlled by the programs related to the algorithms as disclosed in the FIGS. 7 and 9.

It has to be noted here that the device 40 is, in a variant, implemented under the form of one or several dedicated integrated circuits which execute the same operations as the one executed by the processor 400 as disclosed hereinafter.

The bus 401 links the processor 400 to a read only memory ROM 402, a random access memory RAM 403, an analogue to digital converter ADC 406 and the energy conversion device and the electric circuit according to the invention.

The read only memory ROM 402 contains instructions of the programs related to the algorithms as disclosed in the FIGS. 7 and 9 which are transferred, when the device 40 is powered on to the random access memory RAM 403.

The RAM memory 403 contains registers intended to receive variables, and the instructions of the programs related to the algorithms as disclosed in the FIGS. 7 and 9.

The analogue to digital converter 406 is connected to the energy conversion device and the electric circuit according to the invention which forms the power stage 405 and converts voltages and currents if needed into binary information.

FIG. 5a is an example of a merged buck/boost converter able to step-down or to step-up the input voltage without inverting voltage polarity.

The merged buck/boost converter is able, according to the state of switches, to operate in a buck mode (step-down mode) or in a boost mode (step-up mode), without inverting the output voltage polarity as it is done with the classical buck-boost converter.

The merged buck/boost converter comprises an input filter capacitor C_{UI}, which is connected to the power source PV. Voltage measurement means measure the voltage on the capacitor C_{UI}. The positive terminal of the capacitor C_{UI} is connected to a first terminal of a switch S₅. The switch S₅ is for example an IGBT transistor. In that case, the positive terminal of the capacitor C_{UI} is connected to the collector of the IGBT transistor S₅.

The second terminal of switch S₅ is connected to the cathode of a diode D5 and to a first terminal of an inductor L1.

If the switch S₅ is an IGBT transistor, the emitter of the IGBT transistor S₅ is connected to the cathode of the diode D5 and to the first terminal of the inductor L1.

The anode of the diode D5 is connected to the negative terminal of the capacitor C_{UI}.

The second terminal of the inductor L1 is connected to a first terminal of current measurement means.

The second terminal of current measurement means A is connected to the anode of a diode D_{O} and to a first terminal of a switch S₆. The second terminal of the switch S₆ is connected to the negative terminal of the capacitor C_{UI}.

For example the switch S6 is a NMOSFET. In that case, the second terminal of current measurement means A is connected to the drain of the NMOSFET S₆. The source of the NMOSFET S₆ is connected to the negative terminal of the capacitor C_{UI}.

The cathode of the diode D_{O} is connected to the positive terminal of a capacitor C_{O} and the negative terminal of the capacitor C_{O} is connected to the negative terminal of the capacitor C_{UI}.

When the merged buck/boost converter operates in buck mode, the switch S₆ is always in OFF state and diode D_{O} is always conducting.

The switch S₅ is ON during PWM conductive period and is OFF during non conductive period.

When the merged buck/boost converter operates in boost mode, the switch S₅ is always in ON state and diode D₅ is never conducting.

The switch S₆ is ON during PWM conductive period and is OFF during non conductive period.

The switch S₅ contributes to the switching from buck and boost modes. FIG. 5b is an example of a particular implementation of the electric circuit comprising the capacitor according to the present invention in the merged buck/boost converter.

In the particular mode of realisation, components used for the merged buck/boost converter are also used in order to implement the electric circuit according to the invention.

The switch S₅ of FIG. 5a is equivalent to the switch S_{UI} of FIG. 3 when information enabling the determination of the maximum power point are obtained. The capacitor C_{UI} of FIG. 5a is also equivalent to the capacitor C_{UI} of FIG. 3 when the characterization of the power source is performed. The voltage V1 is the same voltage of the capacitor C_{UI} in FIGS. 5a and 3.

FIG. 5b comprises three more components than FIG. 5a: the switch S_{UI}, the resistor R_{UI} and switch S_{UI} already disclosed in FIG. 3.

In that particular implementation, the positive terminal of the power source PV is connected to a first terminal of the switch S_{UI}, to a resistor R_{UI}, to a first terminal of the switch S_{UI2} and to a first terminal of the switch S₅.

The second terminal of switch S_{UI} is connected to the positive terminal of the capacitor C_{UI} and to the second terminal of resistor R_{UI}.

The second terminal of switch S_{UI2} is connected to negative terminal of capacitor C_{UI} and to negative terminal of power source PV.

Voltage measurement means measure the voltage V1 on the capacitor C_{UI}.

The switch S₅ is for example an IGBT transistor and the switches S_{UI} and S_{UI2} are for example NMOSFETs. In that case, the positive terminal of the power source PV is connected to the source of the NMOSFET S_{UI1}, to the drain of the NMOSFET S_{UI2} and to the collector of the IGBT S₅.

The drain of switch S_{UI} is connected to the positive terminal of the capacitor C_{UI} and to the second terminal of resistor R_{UI}.

The source of switch S_{UI2} is connected to negative terminal of capacitor C_{UI} and to negative terminal of power source PV.

The second terminal of switch S₅ is connected to the cathode of a diode D5 and to a first terminal of an inductor L1.

If the switch S₅ is an IGBT transistor, the emitter of the IGBT transistor S₅ is connected to the cathode of the diode D5 and to the first terminal of the inductor L1.

The anode of the diode D5 is connected to the negative terminal of the capacitor C_{UI}.

The second terminal of the inductor L1 is connected to a first terminal of current measurement means.

The second terminal of current measurement means A is connected to the anode of a diode D_{O} and to a first terminal of a switch S₆. The second terminal of the switch S₆ is connected to the negative terminal of the capacitor C_{UI}.

For example the switch S₆ is a NMOSFET. In that case, the second terminal of current measurement means A is connected to the drain of the NMOSFET S₆. The source of the NMOSFET S₆ is connected to the negative terminal of the capacitor C_{UI}.

The cathode of the diode D_{O} is connected to the positive terminal of a capacitor C_{O} and the negative terminal of the capacitor C_{O} is connected to the negative terminal of the capacitor C_{UI}.

In that particular implementation, the switch S5 acts as disclosed in reference to FIG. 5a and as the switch S_{UI3} of FIG. 3.

FIG. 6a is an example of the capacitor voltage variations measured according to the present invention.

The time is represented on horizontal axis of the FIG. 6a and the voltage is represented on the vertical axis of the FIG. 6a.

The voltage V1 represents the voltage on C_{UI}.

Initially, the capacitor C_{UI} is charged to the voltage V_{MPP} corresponding to previously determined MPP. That corresponds to the time period noted PH1 in FIGS. 6a and 6b.

FIG. 6b is an example of power source current variations obtained according to the present invention.

The time is represented on horizontal axis of the FIG. 6b and the current is represented on the vertical axis of the FIG. 6b.

The current represents the output current of the power source PV. During the first time period PH1, the output current I_{MPP} of the power source PV corresponds to previously determined MPP.

During the first time period PH1, the switches S_{UI} and S_{UI3} are in ON state, i.e. in conducting state, and the switch S_{UI2} is in OFF state, i.e. non conducting state if the merged buck/boost converter is operating in the step-up (boost) configuration.

It has to be noted here that, no direct current provided by the power source PV during the first phase PH1, goes through the switch S_{UI1} used for charging the capacitor C_{UI}.

It has to be noted here that, no direct current provided by the power source PV during the first phase PH1 goes through the switch S_{UI2} enabling the discharge of the capacitor C_{UI}, the switch S_{UI2} being in OFF state during the first time period PH1.

The direct current provided by power source PV during the first phase PH1 is intended to the load Lo. The direct current provided by power source PV during the first phase PH1 is converted by the conversion device Conv prior to be used by the load Lo.

In a second time period noted PH2 in FIGS. 6, the capacitor C_{UI} is charged.

During the second time period PH2, the switch S_{UI1} is in ON state and the switches S_{UI2} and S_{UI3} are in OFF state. The capacitor C_{UI} is charged with a current which varies from the short circuit current value I_{SC} to null value current.

The capacitor C_{UI} voltage V1 is monitored in order to determine the MPP.

According to a particular mode of realisation which will be disclosed in FIG. 7, the voltage V1 is monitored in order to determine the output current outputted by the power source PV.

In another mode of realisation, a classical current measuring device is provided in the electric circuit in order to determine the output current outputted by the power source PV.

The capacitor C_{UI} is charged from null value to V_{OC} value.

V1 voltage is sampled in combination with the current if both current sensor and voltage sensors are available, or the current signal is determined from the voltage V1.

In a third time period noted PH3 in FIGS. 6, the capacitor C_{UI} is discharged.

During the third time period PH3, the switches S_{UI1} and S_{UI3} are in OFF state and the switch S_{UI2} is in ON state. The capacitor C_{UI} is discharged through the resistor R_{UI}. The PWM operation of the switch S₆ is stopped at the beginning of time period PH3 and it becomes continuously in ON state. The inductor L1 is discharged through diode D5 and switch S₆. This configuration is also kept during the second time period PH2.

According to a particular mode of realisation which will be disclosed in FIG. 9, the capacitor voltage V1 is monitored in order to determine the capacitor value C_{UI} during the third time period.

The capacitor C_{UI} is discharged to null value and the output current of the power source PV reaches the short circuit current value I_{SC} as the switch S_{UI2} is in ON state.

Consequently, the voltage outputted by the power source PV is kept at null value during the whole time period PH3, in correspondence to I_{SC} current.

During a fourth time period noted PH4 in FIGS. 6, the switches S_{UI1} and S_{UI3} are in ON state (the latter one because the merged buck/boost converter is operating in boost mode), i.e. they are conducting, and the switch S_{UI2} is in OFF state, i.e. not conducting.

During the fourth time period PH4 the output current of the power source PV and the voltage V1 correspond to a newly determined MPP.

The capacitor voltage variations measured according to the present invention are the same as voltage variations of the power source PV output voltage during time periods PH1, PH2 and PH4.

FIG. 7 is an example of an algorithm for determining the maximum power point of the power source according to a particular mode of realisation of the present invention.

More precisely, the present algorithm is executed by the processor 400.

The algorithm for obtaining information enabling the determination of the maximum power point of the power source according to the particular mode of realisation of the present invention uses the voltage V1 in order to determine the current going through the capacitor C_{UI}.

From a general point of view, with the present algorithm, the current for the given sample is determined by multiplying the capacitance value of the capacitor C_{UI} by the voltage derivative of the given sample, the voltage derivative being obtained through a fitted mathematical function, for example a polynomial function with real coefficients.

The fitted mathematical function is obtained by minimizing the sum of the squares of the difference between the measured voltage yᵢ with i=1 to N at consecutive time samples xᵢ and mathematical functions f(xᵢ) in order to obtain a processed voltage for the given time sample. It is done as follows.

Given N samples (x₁,y₁),(x₂,y₂) . . . (x_{N},y_{N}), the required fitted mathematical function can be written, for example, in the form:

f(x)=C₁·f₁(x)+C₂·f₂(x)+ . . . +C_{K}·f_{K}(x)

where fⱼ(x), j=1,2 . . . K are mathematical functions of x and the Cⱼ, j=1,2 . . . K are constants which are initially unknown.

The sum of the squares of the difference between f(x) and the actual values of y is given by

$$\begin{matrix}E = {\sum }_{i = 1}^{N} {[ f ( {x}_{i} ) - {y}_{i} ]}^{2} \\ = {\sum }_{i = 1}^{N} {[ {C}_{1} {f}_{1} ( {x}_{i} ) + {C}_{2} {f}_{2} ( {x}_{i} ) + … + {C}_{K} {f}_{K} ( {x}_{i} ) - {y}_{i} ]}^{2}\end{matrix}$$

This error term is minimized by taking the partial first derivative of E with respect to each of constants, Cⱼ, j=1,2 . . . K and putting the result to zero. Thus, a symmetric system of K linear equation is obtained and solved for C₁, C₂, . . . , C_{K}. This procedure is also known as Least Mean Squares (LMS) algorithm.

Information enabling the determination of the maximum power point are the power-voltage droop characteristics of the power source PV, directly obtained from the current-voltage droop characteristics.

With the voltage samples of V1, a curve is obtained based on the fitting of suitable mathematical functions, for example polynomial functions with real coefficients, in pre-defined windows which will move for each sample as it will disclosed in reference to FIGS. 8a to 8c. Thus, the voltage is filtered and its derivative can be simultaneously calculated for every central point in the window in a very simple and direct way, resulting in the determination of current without the need of any additional current sensor.

At step S700, the processor 400 commands the sampling of voltage V1. The sampling is executed during the time period PH2 of FIGS. 6.

At next step S701, the processor 400 gets the samples obtained at step S700 during the time period PH3. Each sample is bi-dimensional vector the coefficients of which are the voltage value and time to which measured voltage.

At next step S702, the processor 400 determines the size of a moving window. The size of the moving window indicates the number Npt of samples to be used for determining a curve based on the fitting of suitable mathematical functions, for example polynomial functions with real coefficients. The size of the moving window is odd. For example, the size of the moving window is equal to seventy one.

FIG. 8a is an example of a first window which is used to determine a curve based on the fitting of suitable mathematical functions, for example polynomial functions with real coefficients, according to a particular mode of realisation of the present invention.

In FIG. 8a, the horizontal axis represents time and the vertical axis represents measured voltage V1.

Each cross represents a sample.

The window W1 is the moving window and the function f1 is the mathematical function which is determined by the present algorithm.

At next step S703, the processor 400 determines the central point Nc of the moving window.

At next step S704, the processor 400 sets the variable i to the value Npt.

At next step S705, the processor 400 sets the variable j to i−Nc+1.

At next step S706, the processor 400 sets the variable k to one.

At next step S707, the processor 400 sets the value of x(k) to the time coefficient of sample j.

At next step S708, the processor 400 sets the value of y(k) to the voltage coefficient of sample j.

At next step S709, the processor 400 increments the variable k by one.

At next step S710, the processor 400 increments the variable j by one.

At next step S711, the processor 400 checks if the variable j is strictly lower than the sum of i and Nc minored by one.

If the variable j is strictly lower than the sum of i and Nc minored by one, the processor 400 returns to step S707. Otherwise, the processor 400 moves to step S712.

At step S712, the processor 400 determines the fitted mathematical function, for example the polynomial function y(x)=ax²+bx+c, using the Least Mean Square algorithm and all the x(k) and y(k) values sampled at steps S707 and S708 until the condition on S711 is reached.

The mathematical function, for example the second degree polynomial function, is the function f1 shown in FIG. 8a.

The processor 400 obtains then the a, b and c real coefficients of the second degree polynomial function ([a,b,c]ε [symbol] ³).

At next step S713, the processor 400 evaluates the filtered voltage value and the current according to the following formulas:

voltage (time[i])=a·time[i]²+b·time[i]+c

current(time[i])=C_{UI}·(a·time[i]+b)

At next step S714, the processor 400 increments the variable i by one unit.

At next step S715, the processor 400 checks if i is strictly lower than N minored by Nc wherein N is the total number of voltage samples obtained at step S701.

If i is strictly lower than N minored by Nc, the processor 400 returns to step S705. Otherwise, the processor 400 moves to step S716.

By moving to step S705, the processor 400 will displace the moving window by one sample as it is disclosed in reference to FIG. 8b.

FIG. 8b is an example of a second window which is used to determine a curve based on the fitting of suitable mathematical functions, for example polynomial functions with real coefficients, according to a particular mode of realisation of the present invention.

In FIG. 8b, the horizontal axis represents time and the vertical axis represents measured voltage V1.

Each cross represents a sample.

The window W2 is the window W1 moved by one sample and the function f2 is the mathematical function which is determined by the present algorithm at step S712 through the samples available on W2.

The processor 400 will execute the loop constituted by the steps S705 to S715 as far as i is strictly lower than N minored by Nc.

At each loop, the window will be moved by one sample.

FIG. 8c is an example of a third window which is used to determine a curve based on the fitting of suitable mathematical functions, for example polynomial functions with real coefficients, according to a particular mode of realisation of the present invention.

In FIG. 8c, the horizontal axis represents time and the vertical axis represents measured voltage V1.

Each cross represents a sample.

The window W3 is the window W3 moved by one sample and the function f3 is the mathematical function which is determined by the present algorithm at step S712 through the samples available on W3.

At step S716, the processor 400 gets all the voltage and current values determined at the previous steps and forms a curve as the one shown in FIG. 2.

At next step S717, the processor 400 determines the MPP thanks to the voltage and current values obtained at step S716 by selecting the maximum power obtained from voltage and current values.

The new MPP can then be used for an efficient use of the power source PV.

FIG. 9 is an example of an algorithm for determining the capacitance value of the capacitor according to a particular mode of realisation of the present invention.

Electrolytic capacitors are usually chosen as input filter in buck/boost converters like C_{UI}.

Considering the initial value at the first time that an electrolytic capacitor becomes operative, it is well known that the capacitance value will decrease during electrolytic capacitor lifetime. Furthermore, the capacitance value is temperature dependent.

As the current values determined at step S713 are dependent of the capacitance value of C_{UI}, the accuracy of the calculated current strongly depends on the accuracy of the capacitance value.

It is then desirable to accurately estimate the capacitance value, for example, every time that the algorithm disclosed in FIG. 7 will be executed.

During the time period PH3 of FIGS. 6, the voltage V1 is monitored. As C_{UI} is discharged through R_{UI},

$$V 1 ( t ) = V 1 ( t = 0 ) \cdot {e}^{\frac{- t}{{R}_{UI} {C}_{UI}}} .$$

V1(t) is the voltage V1 measured at instant t.

Thus, according to example of FIG. 6a, V1(t=0)=V_{MPP}, where t=0 is the beginning of PH3. When t=τ=R_{UI}C_{UI}, the following equation will be valid:

V1(t=R_{UI}C_{UI})=0.367879.V1(t=0)=0.367879.V_{MPP}.

Since V1(t) is continuously sampled during the time period PH3, when V1(t) reaches above mentioned value, the constant time τ=R_{UI}C_{UI} can be estimated by the processor 400.

Some filtering of the measurements is desired in order to reduce error caused by noise as it will be shown in the algorithm of FIG. 9. Finally, C_{UI} value is estimated from τ and R_{UI}.

Preferably, resistor R_{UI} is a high precision power resistor. For example, the tolerance of resistor R_{UI} is between ±0.05% and ±1%.

At step S900, the processor 400 commands the sampling of voltage V1. The sampling is executed during the time period PH3 of FIGS. 6.

At next step S901, the processor 400 gets the samples obtained at step S900 during the time period PH2. Each sample is bi-dimensional vector the coefficients of which are the voltage value and time to which voltage is measured.

At next step S902, the processor 400 determines a size of a moving window. The size of the moving window indicates the number Npt of samples to be used for determining a curve based on the fitting of suitable polynomial functions. The size of the moving window is odd. For example, the size of the moving window is equal to twenty one.

At next step S903, the processor 400 determines the central point Nc of the moving window.

At next step S904, the processor 400 sets the variable i to the value Npt.

At next step S905, the processor 400 sets the variable j to i−Nc+1.

At next step S906, the processor 400 sets the variable k to one.

At next step S907, the processor 400 sets the value of x(k) to the time coefficient of sample j.

At next step S908, the processor 400 sets the value of y(k) to the voltage coefficient of sample j.

At next step S909, the processor 400 increments the variable k by one.

At next step S910, the processor 400 increments the variable j by one.

At next step S911, the processor 400 checks if the variable j is strictly lower than the sum of i and Nc minored by one.

If the variable j is strictly lower than the sum of i and Nc minored by one, the processor 400 returns to step S907. Otherwise, the processor 400 moves to step S912.

At step S912, the processor 400 determines the mean of the y(k) values accumulated every time that the step S908 is executed for the value i under process.

At next step S913, the processor 400 increments the variable i by one unit.

At next step S914, the processor 400 checks if i is strictly lower than N minored by Nc wherein N is the total number of samples obtained at step S901.

If i is strictly lower than N minored by Nc, the processor 400 returns to step S905. Otherwise, the processor 400 moves to step S915.

By moving to step S905, the processor 400 displaces the moving window by one sample.

At each loop, the window is moved by one sample.

At step S915, the processor 400 gets the voltage values determined every time that the step S912 is executed.

At next step S916, the processor 400 determines the capacitor C_{UI} value using the output filtered voltage determined at step S915 and using following formulas:

τ=R_{UI}C_{UI}

V1(t=R_{UI}C_{UI})=0.367879.V1(t=0)=0.367879.V_{MPP}.

τ is determined by accumulating the sampling period from V_{MPP} at t=0 until 0.367879V_{MPP} at t=τ=R_{UI}C_{UI}.

τ and R_{UI} being known, C_{UI} can then be determined.

Naturally, many modifications can be made to the embodiments of the invention described above without departing from the scope of the present invention.

1-14. (canceled)

15. An apparatus for determining information enabling determination of a maximum power point of a power source providing at a first time period a direct current, the apparatus comprising:
a capacitor;
means for charging the capacitor during a second time period and means for discharging the capacitor in a third time period;
means for monitoring the voltage and the current on the capacitor,
wherein, during the first time period, the direct current does not go through the means for charging the capacitor.

16. An apparatus according to claim 15, wherein the direct current is intended to a load during the first time period.

17. An apparatus according to claim 16, wherein the means for discharging the capacitor includes a resistor and a first switch, a first terminal of the resistor is connected to a first terminal of the power source and to a first terminal of the first switch, a second terminal of the resistor is connected to a first terminal of the capacitor, the second terminal of the capacitor is connected to a second terminal of the power source and to a second terminal of the first switch.

18. An apparatus according to claim 16, wherein the means for charging the capacitor during the second time period comprises a second switch.

19. An apparatus according to claim 18, wherein the second switch is connected in parallel with the resistor.

20. An apparatus according to claim 15, further comprising a third switch for disconnecting the load from the power source during the second and third time periods.

21. An apparatus according to claim 15, wherein the means for monitoring the voltage and the current on the capacitor samples the voltage on the capacitor at consecutive time samples during the second period of time.

22. An apparatus according to claim 15, wherein the means for monitoring the voltage and the current on the capacitor samples the current on the capacitor at consecutive time samples during the second period of time.

23. An apparatus according to claim 21, wherein the measured voltages at consecutive samples surrounding a given sample are processed using a fitted mathematical function which is obtained by minimizing the sum of the squares of the difference between the measured voltages at consecutive samples and mathematical functions to obtain a processed voltage for the given sample.

24. An apparatus according to claim 23, wherein the mathematical functions are polynomial functions of a given order with real coefficients.

25. An apparatus according to claim 24, wherein the current for the given sample is determined by multiplying the capacitance value of the capacitor by the derivative of the fitted mathematical function for the given sample.

26. An apparatus according to claim 24, further comprising means for sampling the voltage on the capacitor during the third time period to determine the capacitance value of the capacitor.

27. An apparatus according to claim 26, wherein the determined capacitance value is used for determining the current for the given sample.

28. An apparatus according to claim 20, wherein the capacitor, the means for monitoring the voltage and the current, and the third switch are components of a merged buck/boost converter.
